(19) United States
(12) Patent Application Publication
(10) Pub. No.: US 2024/0361669 A1
(43) Pub. Date: Oct. 31, 2024

(54) VOICE COIL MOTOR AND CAMERA LENS ASSEMBLY USING THE SAME

(71) Applicant: SAMYANG OPTICS CO., LTD, Changwon-si (KR)

(72) Inventor: Chul SON, Seoul (KR)

(73) Assignee: SAMYANG OPTICS CO., LTD, Changwon-si (KR)

(21) Appl. No.: 18/343,665

(22) Filed: Jun. 28, 2023

(30) Foreign Application Priority Data
Apr. 27, 2023 (KR) 10-2023-0055589

(51) Int. Cl. G03B 13/34; H02K 41/035

(52) U.S. Cl. CPC G03B 13/34; H02K 41/0354

(57) ABSTRACT

A voice coil motor includes a magnet, a yoke accommodating the magnet and extending in a movement axis direction; and a coil member formed by winding a single coil several times in a direction perpendicular to the movement axis direction, wherein the yoke includes a guider inserted into and penetrating through the coil member in the movement axis direction, and guiding a straight line motion of the coil member in the movement axis direction, and among two sides of the coil member extending in the vertical direction, an upper side close to the magnet has a curved shape when observed in the movement axis direction.

### CROSS-REFERENCE TO RELATED APPLICATION

This application claims priority from Korean Patent Application No. 10-2023-0055589 filed on Apr. 27, 2023, in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a voice coil motor, and more particularly, to a voice coil motor capable of providing greater thrust with the same product size and a camera lens assembly using the same.

### 2. Description of the Related Art

Recently, as optical performance of a camera develops, there is a tendency for an aperture of a lens to increase and a weight of a lens to increase. Accordingly, a greater driving force is required to physically move the larger and heavier lens as described above.

However, if the total size of a lens assembly accommodating the lens also increases as the size of the lens increases in order to improve the optical performance of the camera, inconvenience may inevitably be caused to the user.

Therefore, a voice coil motor (VCM) that is compact within a limited size and has high driving force is required.

Considering these demands, Japanese Patent No. 6,457,701 proposes a voice coil motor structure of the form illustrated in FIG. 1.

Referring to FIG. 1, a magnet 2 is fixed to an inner side surface of an upper yoke 5a, and a coil member 3 is inserted into and penetrates through a lower yoke 5b. In this case, a width W1 of the upper yoke 5a is greater than a width W0 of the lower yoke 5b. In addition, the coil member 3 has an upper side L1 longer than a lower side L0. Therefore, the coil member 3 has a trapezoidal shape surrounding the lower yoke 5b as a whole. As a result, it is possible to minimize a reverse thrust compared to a forward thrust through a length difference between the upper and lower sides of the coil member 3.

As such, the prior art proposes a concept of improving a substantial thrust by reducing the length of the lower side of the coil member. However, even through this, there is a limit to increasing the overall width of the coil member providing the thrust of the coil member 3.

As is known, the thrust is improved as the width of the coil member increases, but due to various constraints, the width of the coil member may not be unconditionally increased. Therefore, a technique for increasing the thrust of the voice coil motor within a limited diameter size of the camera lens assembly is still required.

### SUMMARY

Aspects of the present disclosure provide a voice coil motor capable of maximizing a width of a coil member within a limited diameter size of a camera lens assembly.

Aspects of the present disclosure also provide a voice coil motor having an optimized structure considering that a camera lens, a lens holder, and a lens assembly accommodating the camera lens and the lens holder all have circular cross-sectional structures.

However, aspects of the present invention are not restricted to those set forth herein. The above and other aspects will become more apparent to one of ordinary skill in the art to which the disclosure pertains by referencing the detailed description of the present invention given below.

According to an aspect of an exemplary embodiment, there is provided a voice coil motor comprising: a magnet; a yoke accommodating the magnet and extending in a movement axis direction; and a coil member formed by winding a single coil several times in a direction perpendicular to the movement axis direction, wherein the yoke includes a guider inserted into and penetrating through the coil member in the movement axis direction, and guiding a straight line motion of the coil member in the movement axis direction, and among two sides of the coil member extending in the vertical direction, an upper side close to the magnet has a curved shape when observed in the movement axis direction.

The coil member has a shape of a first arc based on the center of a common circle when observed in the direction of the movement axis.

The magnet has a shape of a second arc concentric with the center of the common circle when observed in the movement axis direction.

The two sides of the coil member, a lower side far from the magnet has a straight line shape when observed in the movement axis direction, and an upper surface and a lower surface of a cross section of the guider based on the movement axis all have a curved shape corresponding to the upper side of the coil member.

Among the two sides of the coil member, a lower side far from the magnet has a straight line shape when observed in the movement axis direction, an upper surface of a cross section of the guider based on the movement axis has a curved shape corresponding to the upper side of the coil member, and a lower surface of the cross section of the guider based on the movement axis has a straight line shape corresponding to the curved shape of the coil member.

A connecting portion connecting the upper side and the lower side of the coil member extends in a direction perpendicular to both the movement axis direction and the vertical direction when observed in the movement axis direction.

A width of the magnet and a width of the guider have a size corresponding to a width of an inner surface of the connecting portion.

A width of the guider has a size corresponding to a width of an inner surface of the connecting portion, and a width of the magnet has a size corresponding to a width of an outer surface of the connecting portion.

A connecting portion connecting the upper side and the lower side of the coil member extends in a direction toward the center of the common circle when observed in the movement axis direction.

An angle formed by an arc of the magnet and an angle of an arc formed by the guider based on the center of the common circle correspond to an angle of an arc formed by a lower surface of the upper side of the coil member.

An angle formed by an arc of the magnet based on the center of the common circle corresponds to an angle of an arc formed by an outer surface of the upper side of the coil member, and an angle formed by an arc of the guider based on the center of the common circle corresponds to an angle of an arc formed by a lower surface of the upper side of the coil member.

An angle formed by an arc of the magnet based on the center of the common circle is greater than an angle of an arc formed by an outer surface of the upper side of the coil member, and an angle formed by an arc of the guider based on the center of the common circle corresponds to an angle of an arc formed by a lower surface of the upper side of the coil member.

The coil member includes a plurality of individual coil members, and the plurality of coil members are all electrically connected to each other.

The coil member is manufactured by winding the coil member around a jig in which a first surface has a shape corresponding to the upper side of the coil member and a second surface opposite to the first surface has a straight-line shape.

The coil member is manufactured in a self-bonding type.

According to another aspect of an exemplary embodiment, there is provided a camera lens assembly comprising: a lens; a lens housing accommodating the lens; a lens holder which holds the lens and is movable together with the lens in a movement axis direction with respect to the lens housing; a yoke accommodated on one side of the lens housing and extending in the movement axis direction; a magnet accommodated in the yoke; and a coil member produced by winding a single coil several times in a direction perpendicular to the movement axis direction and accommodated on one side of the lens holder, wherein the yoke includes a guider inserted into and penetrating through the coil member in the movement axis direction, and guiding a straight line motion of the coil member and the lens holder in the movement axis direction, and among two sides of the coil member extending in the vertical direction, an upper side close to the magnet has a curved shape when observed in the movement axis direction.

According to the voice coil motor according to the present disclosure, the thrust of the voice coil motor may be improved without excessively increasing the overall size of the coil member.

Further, according to the voice coil motor according to the present disclosure, it is possible to maximize the aperture of the accommodated lens while sufficiently securing the thrust of the voice coil motor within the limited diameter size.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a view illustrating an example of a conventional voice coil motor;

FIG. 2A is a longitudinal cross-sectional view of a camera lens assembly according to an exemplary embodiment of the present disclosure, and FIG. 2B is an exploded perspective view of the camera lens assembly;

FIG. 3A is an assembled view of a voice coil motor according to the present disclosure, and FIG. 3B is an exploded perspective view of the voice coil motor;

FIGS. 4A and 4B are cross-sectional views of a voice coil motor 50-1 according to a first exemplary embodiment of the present disclosure;

FIGS. 5A and 5B are cross-sectional views of a voice coil motor 50-2 according to a second exemplary embodiment of the present disclosure;

FIGS. 6A and 6B are cross-sectional views of a voice coil motor 50-3 according to a third exemplary embodiment of the present disclosure;

FIGS. 7A and 7B are cross-sectional views of a voice coil motor 50-4 according to a fourth exemplary embodiment of the present disclosure; and

FIG. 8 is a cross-sectional view of a voice coil motor 50-5 according to a fifth exemplary embodiment of the present disclosure.

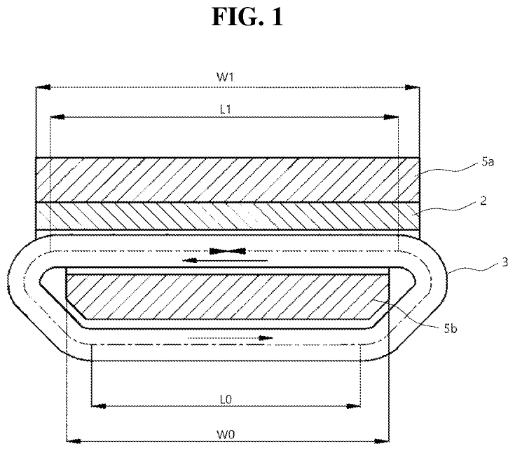

### DETAILED DESCRIPTION OF THE EMBODIMENTS

Advantages and features of the disclosure and methods to achieve them will become apparent from the descriptions of exemplary embodiments herein below with reference to the accompanying drawings. However, the inventive concept is not limited to exemplary embodiments disclosed herein but may be implemented in various ways. The exemplary embodiments are provided for making the disclosure of the inventive concept thorough and for fully conveying the scope of the inventive concept to those skilled in the art. It is to be noted that the scope of the disclosure is defined only by the claims. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the present disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

Hereinafter, exemplary embodiments of the present disclosure will be described in detail with reference to the accompanying drawings.

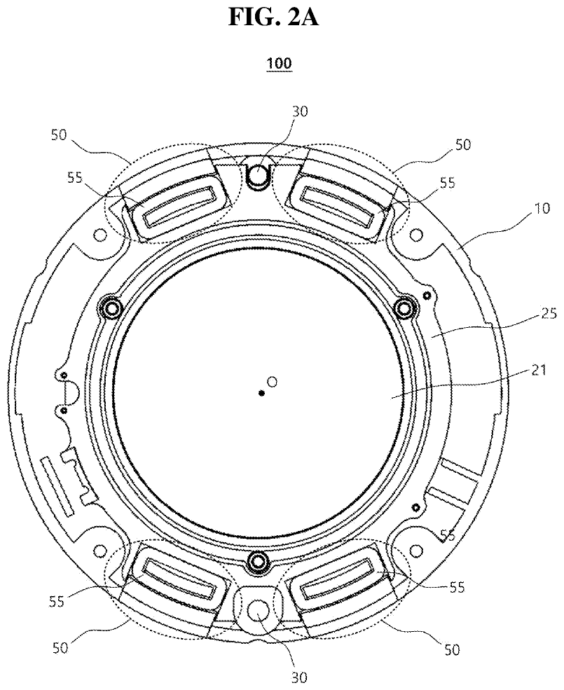

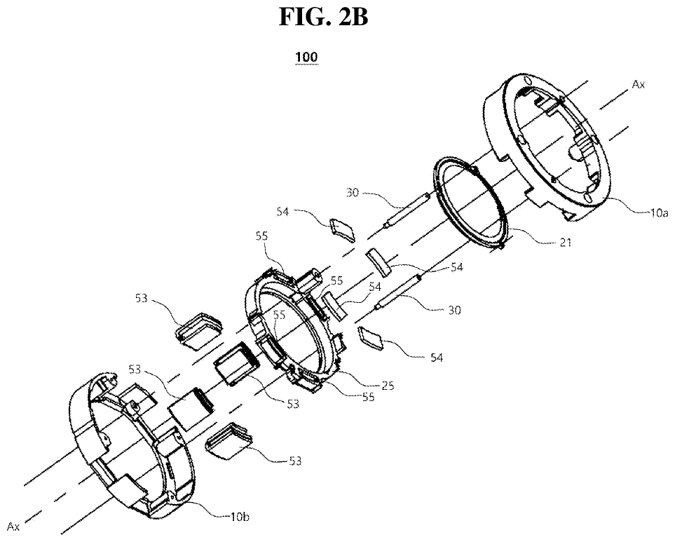

FIG. 2A is a longitudinal cross-sectional view of a camera lens assembly 100 according to an exemplary embodiment of the present disclosure, and FIG. 2B is an exploded perspective view of the camera lens assembly 100.

Here, each component is disposed on a circumference based on a center (a center of a common circle) O of a lens 21. The lens 21 is mounted on a lens holder 25, and the lens 21 and the lens holder 25 are accommodated in a lens housing 10. In this case, in order to perform a focusing function of the lens, the lens and the lens holder 25 are movable in an optical axis or focusing movement axis direction (Ax in FIG. 2B).

In this case, a plurality of voice coil motors 50 may be installed at a plurality of positions between the lens housing 10 and the lens holder 25 along a circumferential direction of the lens housing 10. The plurality of voice coil motors 50 may be disposed at an equal angle along the circumferential direction, but may also be disposed adjacent to each other in each pair as illustrated in FIG. 2A in consideration of an installation space of other components.

Referring to FIG. 2B, the lens housing 10 may include a first part 10a and a second part 10b, and other components may be accommodated therebetween.

The lens 21 is mounted on the lens holder 25, and a coil member 55 of the voice coil motor 50 is accommodated on one side of the lens holder 25. In addition, a yoke 53 accommodating a magnet is fixedly disposed on the first part 10a of the lens housing 10. In this case, the yoke 53 has a structure in which a guider formed on the yoke 53 is inserted into and penetrates through the coil member 55, and in a state in which the coil member 55 is inserted into the yoke 53, the yoke 53 may be closed by a closing plate 54.

In addition, the movement of the lens holder 25 in the movement axis direction Ax may be guided by a plurality of connecting rods 30 connecting the parts 10a and 10b of the lens housing 10 together with the guider of the yoke 53.

In FIG. 2A, a plurality of coil members 55 are disposed at positions spaced apart from each other, but all of the plurality of coil members 55 are electrically connected. That is, although not illustrated, the plurality of coil members 55 are connected to each other by coils. Through this, the respective voice coil motors 50 may be integrally controlled by a single current supply. The coil member 55 is manufactured by winding a single coil several times in a direction perpendicular to the movement axis direction Ax. Specifically, the coil member 55 has a structure without a bobbin, and may be manufactured as a strong member by heating an adhesive applied to the outside of the wound coil (self-bonding type).

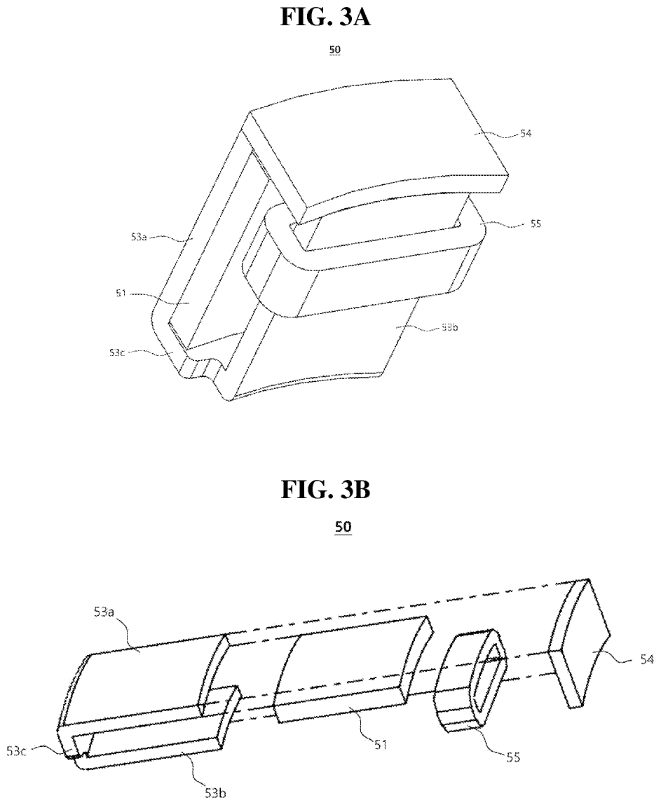

FIG. 3A is an assembled view of a voice coil motor 50 according to the present disclosure, and FIG. 3B is an exploded perspective view of the voice coil motor 50.

The yoke 53 is configured in a ‘U’ shape, including an upper plate 53a, a lower plate 53b, and a connecting portion 53c connecting the upper plate 53a and the lower plate 53b, and accommodates the magnet 51 therein. In addition, the coil member 55 may be inserted into the lower plate 53b, and may move along the lower plate 53b in the movement axis direction Ax. Therefore, in view of guiding the movement of the coil member 55, the lower plate 53b will be referred to as a “guider 53b” in the following. In a state in which the guider 53b is inserted into and penetrates through the coil member 55, the yoke 53 may be closed by the closing plate 54.

As illustrated in FIG. 3A, when a current is supplied to the coil member 55 in a state in which the coil member 55 is inserted into the guider 53b, a direction of a magnetic field and a direction of the current are perpendicular to each other due to the magnet 51 positioned above the coil member 55. Therefore, according to an electromagnetic induction phenomenon, the coil member 55 receives thrust and moves in a direction perpendicular to both directions, that is, in an extension direction of the guider 53b or the movement axis direction Ax. As a result, if the yoke 53 accommodating the magnet 51 is installed in the lens housing 10 and the coil member 55 is installed in the lens holder 25, the lens 21 mounted on the lens holder 25 may be moved in the optical axis or movement axis direction Ax by the current supply.

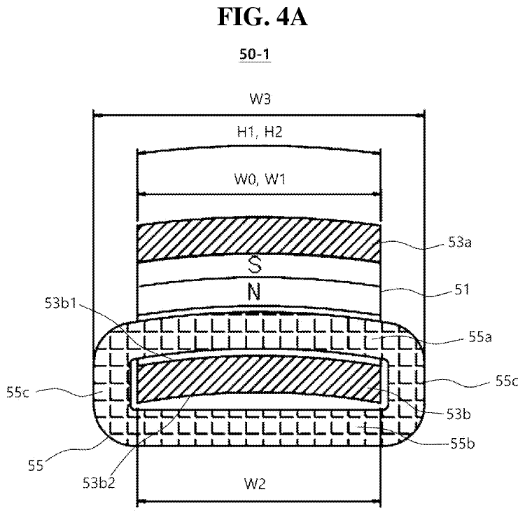

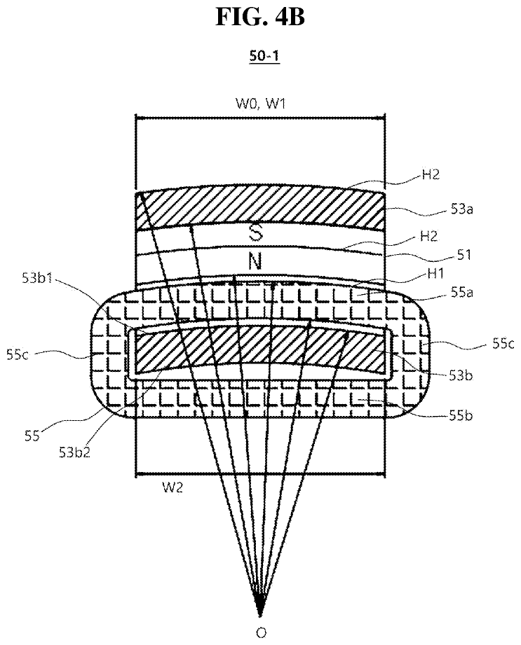

FIGS. 4A and 4B are cross-sectional views of a voice coil motor 50-1 according to a first exemplary embodiment of the present disclosure.

Among the two sides 55a and 55b of the coil member 55 extending in a lateral direction, an upper side 55a, which is close to the magnet 51, has a curved shape when observed in the movement axis direction Ax.

Specifically, the coil member 55 has a shape of a first arc H1 based on the center O of a common circle when observed in the movement axis direction Ax, and the magnet 51 and the upper plate 53a of the yoke 53 have a shape of a second arc H2 concentric with the center O of the common circle when observed in the movement axis direction Ax. In this case, a width of the first arc H1 is substantially the same as that of the second arc H2.

Among the two sides 55a and 55b of the coil member 55, a lower side 55b far from the magnet 51 has a straight line shape when observed in the movement axis direction Ax, and an upper surface 53b1 and a lower surface 53b2 of a cross section of the guider 53b based on the movement axis Ax all have a curved shape corresponding to the upper side 55a of the coil member 55. However, the lower surface 53b2 of the guider 53b may also be formed in a straight line shape to correspond to the lower side 55b of the coil member 55, unlike that illustrated in FIG. 4A.

A connecting portion 55c connecting the upper side 55a and the lower side 55b of the coil member 55 extends in a direction (a vertical direction in FIG. 4A) perpendicular to both the movement axis direction Ax and the lateral direction (a longitudinal direction of the lower side 55b) when observed in the movement axis direction Ax.

In addition, a width W0 of the magnet 51 and a width W1 of the guider 53b having a size corresponding to a width W2 of an inner surface of the connecting portion 55c of the coil member 55. Therefore, the width W0 of the magnet 51 and the width W1 of the guider 53b are smaller than a width W3 of an outer surface of the connecting portion 55c of the coil member 55.

Meanwhile, referring to FIG. 4B, the upper plate 53a of the yoke, the magnet 51, the upper side 55a of the coil member 55, and the guider 53b of the voice coil motor 50-1 according to the first exemplary embodiment all have an arc shape based on the center O of the common circle. In this way, when each member is formed in the arc shape with the center O of the common circle, various members may be disposed in an outer space (ring shape) of the lens 21 in the lens housing 10 as efficiently as possible.

In addition, in the exemplary embodiments of the present disclosure, since the upper side 55a of the coil member 55 has the arc shape, it is possible to secure a relatively long current path compared to the conventional coil member having a straight upper side (length of arc of H1>width of H1), which may lead to an increase in the thrust of the voice coil motor 50. However, the lower side 55b is configured in a straight line shape rather than the arc shape. Since the lower side 55b needs to be spaced apart from the upper side 55a to some extent, and a force in an opposite direction to the thrust, that is, a force that interferes with the thrust, acts on the lower side 55b, it is advantageous to reduce a length of the lower side 55b. Accordingly, in the exemplary embodiments of the present disclosure, the upper side 55a of the coil member 55 has the arc shape, and the lower side 55b thereof has the straight line shape.

Such an improved coil member 55 may be manufactured by winding the coil member 55 around a jig in which a first surface has a convex shape corresponding to the shape of the upper side 55a of the coil member 55, and a second surface opposite to the first surface has a straight line shape several times. Thereafter, when the adhesive applied to the outside of the wound coil is heated and solidified, the shape of the coil member 55 may be maintained as it is.

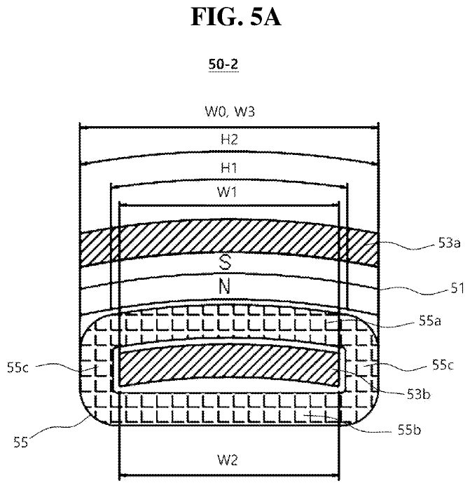

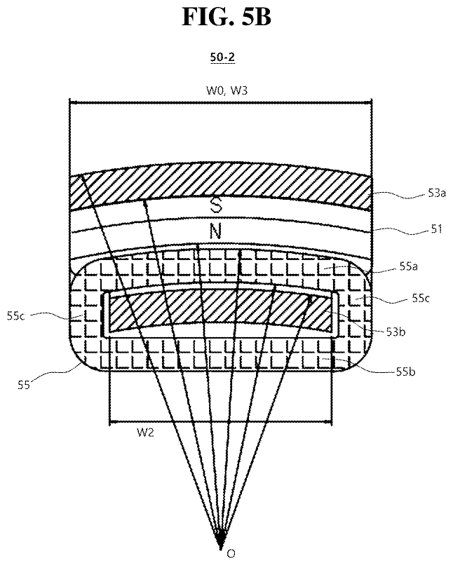

FIGS. 5A and 5B are cross-sectional views of a voice coil motor 50-2 according to a second exemplary embodiment of the present disclosure.

The voice coil motor 50-2 is generally similar to the voice coil motor 50-1 described above, but differs from the voice coil motor 50-1 in that lengths of the upper plate 53a of the yoke and the magnet 51 are increased compared to the first exemplary embodiment.

Specifically, the width W1 of the guider 53b has a size corresponding to (substantially the same as) the width W2 of the lower surface (inner surface) of the connecting portion 55c of the coil member 55, but the width W0 of the magnet 51 and the upper plate 53a of the yoke has a size corresponding to the width W3 of the outer surface of the connecting portion 55c of the coil member 55. According to the second exemplary embodiment, since the sizes of the upper plate 53a of the yoke 53 and the magnet 51 are increased, an effective magnetic flux applied to the same coil member 55 may be increased, which may contribute to improving the thrust of the voice coil motor 50-2. This is because, if the width of the magnet 51 is the same as that of the coil member 55, a sufficient magnetic flux may not be provided to the vicinity of the left and right ends of the coil member.

Referring to FIG. 5B, the upper plate 53a of the yoke, the magnet 51, the upper side 55a of the coil member 55, and the guider 53b of the voice coil motor 50-2 according to the second exemplary embodiment all have an arc shape based on the center O of the common circle.

In the first and second exemplary embodiments described above, the left and right ends of the yoke 53, the magnet 51, and the coil member 55 are formed in a vertical direction. However, since the outer space of the lens 21 in the lens housing 10 has a structure of a ring shape, it may be more preferable that the left and right ends are formed in a direction along the center O of the common circle in order to make maximum use of the outer space. Accordingly, third to fifth exemplary embodiments of the present disclosure will be described below.

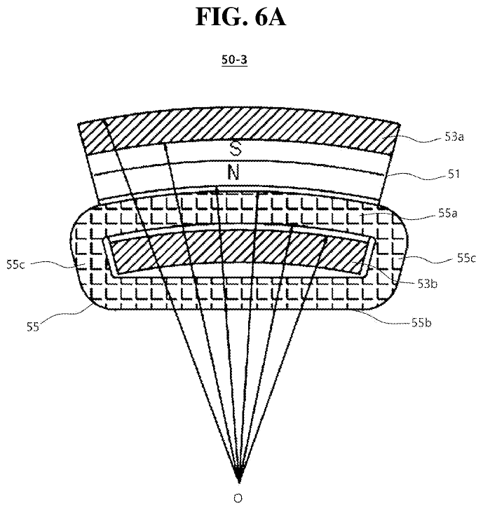

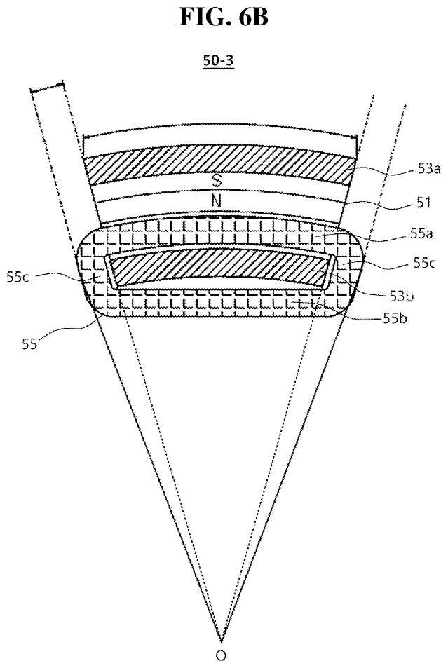

FIGS. 6A and 6B are cross-sectional views of a voice coil motor 50-3 according to a third exemplary embodiment of the present disclosure.

Here, when observed in the movement axis direction Ax, the left and right ends of the upper plate 53a of the yoke 53, the magnet 51, and the lower plate 53b of the yoke 53 may all extend in a direction passing through the center O of the common circle. Similarly, both the inner and outer surfaces of the connecting portion 55c connecting the upper side 55a and the lower side 55b of the coil member 55 may extend in a direction toward the center O of the common circle.

However, in the third exemplary embodiment, an angle formed by the arc of the magnet 51 based on the center O of the common circle and an angle of the arc formed by the guider 53b correspond (substantially the same) to an angle of the arc formed by the lower surface (inner surface) of the upper side 55a of the coil member 55.

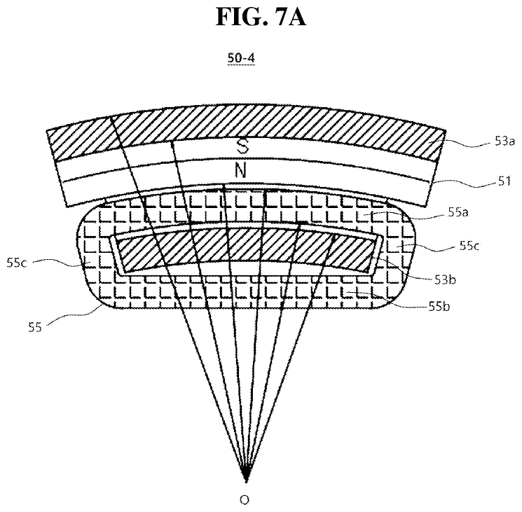

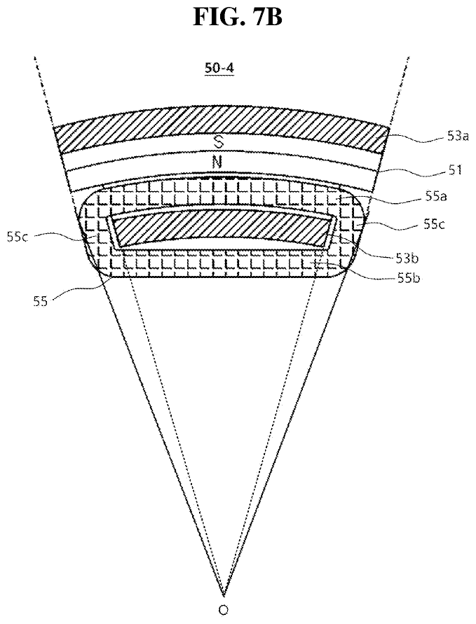

FIGS. 7A and 7B are cross-sectional views of a voice coil motor 50-4 according to a fourth exemplary embodiment of the present disclosure.

Here, also, when observed in the movement axis direction Ax, the left and right ends of the upper plate 53a of the yoke 53, the magnet 51, and the lower plate 53b of the yoke 53 may all extend in a direction passing through the center O of the common circle. Similarly, both the inner and outer surfaces of the connecting portion 55c connecting the upper side 55a and the lower side 55b of the coil member 55 may extend in a direction toward the center O of the common circle.

However, in the fourth exemplary embodiment, the angle formed by the arc of the magnet 51 based on the center O of the common circle corresponds to the angle of the arc formed by the outer surface of the upper side 55a of the coil member 55, and the angle of the arc formed by the guider 53b based on the center O of the common circle corresponds to the angle of the arc formed by the lower surface (inner surface) of the upper side 55a of the coil member 55. According to the fourth exemplary embodiment, since the angle of the upper plate 53a of the yoke 53 and the magnet 51 is increased compared to the third exemplary embodiment, but is not greater than that of the outer surface of the coil member 55, a maximum thrust may be obtained within a limited angle range.

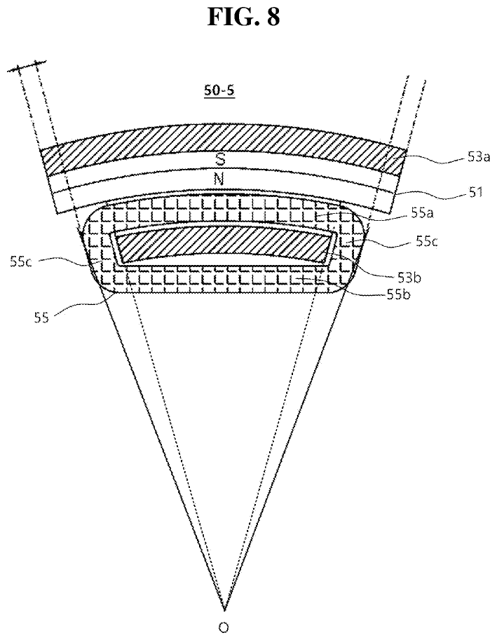

FIG. 8 is a cross-sectional view of a voice coil motor 50-5 according to a fifth exemplary embodiment of the present disclosure.

Here, the angle formed by the arc of the magnet 51 based on the center O of the common circle is greater than the angle of the arc formed by the outer surface of the upper side 55a of the coil member 55, and the angle of the arc formed by the guider 53b based on the center O of the common circle corresponds (substantially the same) to the angle of the arc formed by the lower surface (inner surface) of the upper side 55a of the coil member 55. According to the fifth exemplary embodiment, since the sizes of the upper plate 53a of the yoke 53 and the magnet 51 are further increased, an effective magnetic flux applied to the same coil member 55 may be further increased, which may contribute to improving the thrust of the voice coil motor 50-4. However, it should be taken into account that an angle range of the upper plate 53a of the yoke 53 and the magnet 51 is greater than that of the outer surface of the coil member 55.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A voice coil motor comprising:
a magnet;
a yoke accommodating the magnet and extending in a movement axis direction; and
a coil member formed by winding a single coil several times in a direction perpendicular to the movement axis direction,
wherein the yoke includes a guider inserted into and penetrating through the coil member in the movement axis direction, and guiding a straight line motion of the coil member in the movement axis direction, and
among two sides of the coil member extending in the vertical direction, an upper side close to the magnet has a curved shape when observed in the movement axis direction.

2. The voice coil motor of claim 1, wherein the coil member has a shape of a first arc based on the center of a common circle when observed in the direction of the movement axis.

3. The voice coil motor of claim 2, wherein the magnet has a shape of a second arc concentric with the center of the common circle when observed in the movement axis direction.

4. The voice coil motor of claim 3, wherein among the two sides of the coil member, a lower side far from the magnet has a straight line shape when observed in the movement axis direction, and
an upper surface and a lower surface of a cross section of the guider based on the movement axis all have a curved shape corresponding to the upper side of the coil member.

5. The voice coil motor of claim 3, wherein among the two sides of the coil member, a lower side far from the magnet has a straight line shape when observed in the movement axis direction,
an upper surface of a cross section of the guider based on the movement axis has a curved shape corresponding to the upper side of the coil member, and
a lower surface of the cross section of the guider based on the movement axis has a straight line shape corresponding to the curved shape of the coil member.

6. The voice coil motor of claim 4, wherein a connecting portion connecting the upper side and the lower side of the coil member extends in a direction perpendicular to both the movement axis direction and the vertical direction when observed in the movement axis direction.

7. The voice coil motor of claim 6, wherein a width of the magnet and a width of the guider have a size corresponding to a width of an inner surface of the connecting portion.

8. The voice coil motor of claim 6, wherein a width of the guider has a size corresponding to a width of an inner surface of the connecting portion, and
a width of the magnet has a size corresponding to a width of an outer surface of the connecting portion.

9. The voice coil motor of claim 3, wherein a connecting portion connecting the upper side and the lower side of the coil member extends in a direction toward the center of the common circle when observed in the movement axis direction.

10. The voice coil motor of claim 9, wherein an angle formed by an arc of the magnet and an angle of an arc formed by the guider based on the center of the common circle correspond to an angle of an arc formed by a lower surface of the upper side of the coil member.

11. The voice coil motor of claim 9, wherein an angle formed by an arc of the magnet based on the center of the common circle corresponds to an angle of an arc formed by an outer surface of the upper side of the coil member, and
an angle formed by an arc of the guider based on the center of the common circle corresponds to an angle of an arc formed by a lower surface of the upper side of the coil member.

12. The voice coil motor of claim 9, wherein an angle formed by an arc of the magnet based on the center of the common circle is greater than an angle of an arc formed by an outer surface of the upper side of the coil member, and
an angle formed by an arc of the guider based on the center of the common circle corresponds to an angle of an arc formed by a lower surface of the upper side of the coil member.

13. The voice coil motor of claim 1, wherein the coil member includes a plurality of individual coil members, and
the plurality of coil members are all electrically connected to each other.

14. The voice coil motor of claim 1, wherein the coil member is manufactured by winding the coil member around a jig in which a first surface has a shape corresponding to the upper side of the coil member and a second surface opposite to the first surface has a straight line shape.

15. The voice coil motor of claim 1, wherein the coil member is manufactured in a self-bonding type.

16. A camera lens assembly comprising:
a lens;
a lens housing accommodating the lens;
a lens holder which holds the lens and is movable together with the lens in a movement axis direction with respect to the lens housing;
a yoke accommodated on one side of the lens housing and extending in the movement axis direction;
a magnet accommodated in the yoke; and
a coil member produced by winding a single coil several times in a direction perpendicular to the movement axis direction and accommodated on one side of the lens holder,
wherein the yoke includes a guider inserted into and penetrating through the coil member in the movement axis direction, and guiding a straight line motion of the coil member and the lens holder in the movement axis direction, and
among two sides of the coil member extending in the vertical direction, an upper side close to the magnet has a curved shape when observed in the movement axis direction.
